(19) United States
(12) Patent Application Publication
(10) Pub. No.: US 2006/0039675 A1
(43) Pub. Date: Feb. 23, 2006

(54) Streaming apparatus and streaming method

(75) Inventors: Chi-hurn Kim, Hwaseong-si (KR); Cheol-hong An, Suwon-si (KR); Yong-kuk You, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/193,348

(22) Filed: Aug. 1, 2005

(30) Foreign Application Priority Data
Aug. 20, 2004 (KR) 10-2004-0065887

(51) Int. Cl. H04N 5/91

(52) U.S. Cl. 386/65

(57) ABSTRACT

A streaming apparatus and method that streams AV data to other devices and converts the recording time stamp into a streaming time stamp format, thereby simplifying the streaming process.

### CROSS-REFERENCE TO RELATED APPLICATIONS

This application claims the priority of Korean Patent Application No. 2004-65887, filed on Aug. 20, 2004, in the Korean Intellectual Property Office, the disclosure of which is incorporated herein in its entirety by reference.

### BACKGROUND OF THE INVENTION

1. Field of the Invention

The present invention relates to a streaming apparatus and a streaming method, and more particularly, to a streaming apparatus and a streaming method, in which a streaming process is simplified by converting a recording time stamp into a streaming time stamp when streaming the contents recorded on a storage medium.

2. Description of Related Art

Recently, interests in digital home networks have increased. A home network can integrate many kinds of technologies for interconnecting a plurality of devices in a customer premise with each other, to implement various operations such as playback and recording of AV data, message delivery, and control of other devices, thus accommodating users' conveniences.

One of the home network application fields is multimedia playback and recording. Typically, for multimedia data playback and recording in a home network, AV data is transmitted from an external source through a digital broadcast and stored in a home server. In that case, the home server functions as a blue-ray disc (BD) player as well as a streaming server for streaming AV data to other devices in the home network. Also, the AV data is typically stored in a storage medium such as a blue-ray disc or a DVD in the home server in a compressed format using moving-picture technologies such as MPEG2. For this purpose, an MPEG2 transport stream (TS) is usually used as a data type for transmitting data to the home network and between devices in the home network.

FIG. 1 illustrates a conventional streaming apparatus.

The conventional streaming apparatus 100 includes a decryption unit 20 for extracting and decrypting AV data from the storage medium 10, a playback de-packetizer 30 for extracting a recording time stamp from the decrypted AV data 22 and reorganizing their packets according to the extracted time stamp, a decoder 60 for decoding the transport packets 32 to produce image signals 62, a display unit 70 for displaying the image signals to users, a streaming de-packetizer 40 for recording the streaming time stamp on the source transport packets 32 again to reorganize the streaming packets 42, and a transmission unit 50 for transmitting the streaming packets 42 to other devices according to a predetermined streaming protocol. A clock counter 35 generates clock signals necessary for each playback de-packetizer to reorganize the transport packets based on the recording time stamp, and the other clock counter 45 generates clock signals necessary for the streaming de-packetizer 40 to create the streaming time stamp.

A combination of components 20, 30, 40, and 50 shown in FIG. 1 can constitute a streaming apparatus, and a combination of components 20, 30, 60, and 70 can constitute a playback apparatus. The streaming apparatus and the playback apparatus can be implemented together on a home server in the home network.

When the home server receives AV data through a digital broadcast and stores it on a disc in the home server, or when the home server plays back AV data recorded on a disc and displays it to users or performs a streaming to other devices, it is important to load the AV data based on accurate timing information. For this purpose, temporal information called a time stamp is inserted inside each packet of the AV data. In other words, a time stamp is generated in the packet of the AV data when the home server stores the AV data received through a digital broadcast on a blue-ray disc (i.e., a recording time stamp). In addition, another time stamp is generated in each packet of the AV data when the home server extracts the AV data from the disc and performs a streaming operation (i.e., a streaming time stamp).

However, the recording time stamp and the streaming time stamp have different purposes and formats. For example, when an MPEG2 transport stream is stored in a storage medium, a recording time stamp of 30 bits is used. On the contrary, a digital home networking group (DHWG) technology standard utilizes a streaming time stamp of 32 bits. Therefore, in a typical home server, conventional time stamp technologies require creation of the streaming time stamp when the AV data is streamed, after the recording time stamp is created.

### SUMMARY OF THE INVENTION

The present invention provides an apparatus and method of streaming AV data, in which a streaming process is simplified by converting a recording time stamp into a streaming time stamp without a separate process for creating the streaming time stamp when a home server streams AV data to other devices.

Consistent with an aspect of one embodiment, there is provided an apparatus for streaming AV data to other devices, each packet in the AV data having a recording time stamp of m bits representing temporal information of when the packet is recorded on a storage medium. The apparatus can include: a time stamp converter unit converting the recording time stamp of m bits into a streaming time stamp of n bits required for streaming the AV data to other devices (here, m<n); and a transmission unit transmitting packets including the streaming time stamp to other devices based on a predetermined streaming protocol.

The time stamp converter unit may generate the streaming time stamp by: filling the most significant (n-m) bits of the streaming time stamp of a first packet with zeros and filling the remaining m bits with the recording time stamp of the first packet; and filling the most significant (n-n) bits of the streaming time stamp of an ith packet with a bit value obtained by incrementing the most significant (n-m) bits of the streaming time stamp of an (i-1)th packet as many as one bit, when the recording time stamp of the ith packet of the AV data is smaller than that of the (i-1)th packet.

The time stamp converter unit may generate the streaming time stamp by filling the most significant (n-n) bits of the streaming time stamp of the ith packet with the streaming time stamp of the (i-1)th packet when the recording time stamp of the ith packet is larger than or equal to that of the (i-1)th packet.

The time stamp converter unit may fill lower m bits of the streaming time stamp of the ith packet with the recording time stamp of the ith packet.

Consistent with another exemplary embodiment, there is provided a method of streaming AV data to other devices, each packet of the AV data having a recording time stamp of m bits representing temporal information on when the packet is to be recorded on a storage medium, the method comprising: converting the recording time stamp of m bits into a streaming time stamp of n bits required for streaming the AV data to other devices (here, m<n); and transmitting packets including the streaming time stamp to other devices based on a predetermined streaming protocol.

The conversion of the recording time stamp may include: filling the most significant (n-m) bits of the streaming time stamp of a first packet with zeros and filling remaining m bits with the recording time stamp of the first packet; and filling the most significant (n-m) bits of the streaming time stamp of an ith packet with a bit value obtained by incrementing the most significant (n-m) bits of the streaming time stamp of an (i-1)th packet as many as one bit, when the recording time stamp of the ith packet of the AV data is smaller than that of the (i-1)th packet.

Consistent with still another exemplary embodiment, there is provided a method of converting a recording time stamp of m bits of AV data containing one or more packets into a streaming time stamp of n bits (here, m<n), comprising: extracting the recording time stamp of an ith packet; filling the most significant (n-m) bits of the streaming time stamp of a first packet with zeros and filling the remaining lower m bits with the recording time stamp of the first packet; comparing the recording time stamp Xi of the ith packet with the recording time stamp X(i-1) of the (i-1)th packet; and filling the most significant (n-m) bits of the streaming time stamp Yi of an ith packet with a bit value obtained by incrementing the most significant (n-m) bits of the streaming time stamp Y(i-1) of an (i-1)th packet as many as one bit and filling the lower m bits of the streaming time stamp Yi of the ith packet with the recording time stamp Xi when Xi<X(i-1).

Consistent with still another embodiment, there is provided a home server in a digital home network including the streaming apparatus described above.

### BRIEF DESCRIPTION OF THE DRAWINGS

The above and other features and advantages of the present invention will become more apparent by describing in detail, exemplary embodiments thereof with reference to the attached drawings, in which:

FIG. 1 illustrates a conventional streaming apparatus;

FIG. 2 illustrates an example of a home network performing a streaming process;

FIG. 3 illustrates a process of converting a format to store an MPEG2 transport stream in a storage medium;

FIG. 4 illustrates a format for storing an MPEG2 transport stream in a storage medium;

FIG. 5 illustrates a streaming apparatus consistent with an embodiment of the present invention;

FIG. 6 illustrates a principle of time stamp conversion; and

FIG. 7 illustrates a method of converting a recording time stamp into a streaming time stamp consistent with one embodiment of the present invention.

### DETAILED DESCRIPTION OF THE INVENTION

Now, exemplary embodiments of the present invention will be described in detail with reference to the accompanying drawings.

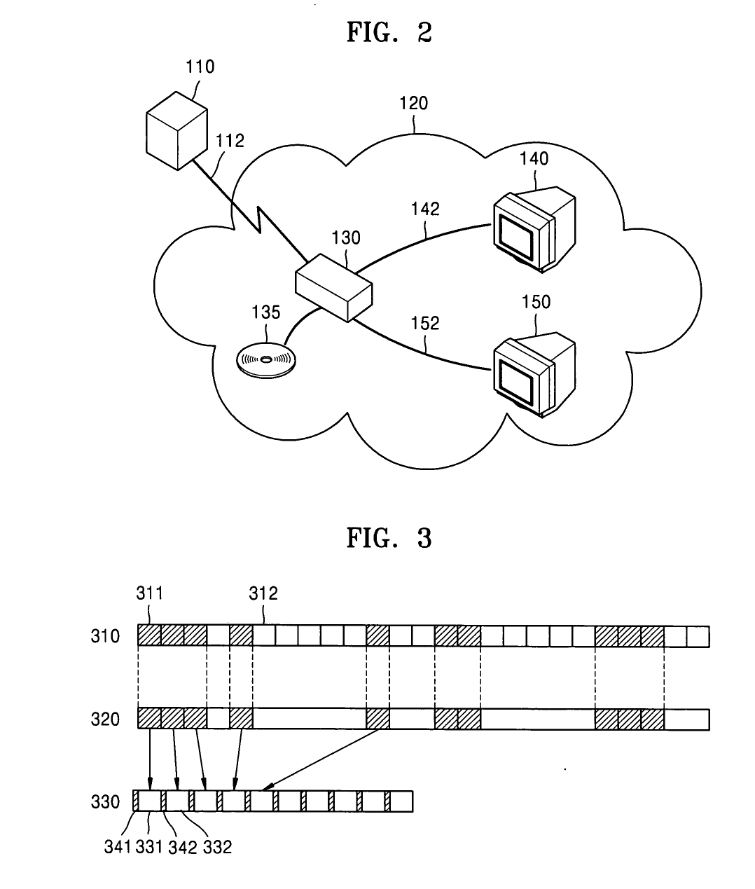

FIG. 2 is a network diagram illustrating an example of a home network for streaming contents.

An external content source 110 transmits contents to a home server 130 via various potential transmission channels (e.g., cable TV network, satellite network, and/or the Internet). The transmission may be a digital broadcast service or a content download, and the present invention is not limited to any particular transmission type. The contents are stored in a storage medium 135 in the home server 130. Then, the contents are displayed on a display unit of the home server 130 or sent to other devices 140, 150 in the home network by streaming. The contents may include A/V data.

Typically, when the AV data transmission to the home server is accomplished by digital broadcasting, it is transmitted in a format of an MPEG2 transport stream (TS). The MPEG transport stream includes time-multiplexed packets representing several programs. The home server 130 receives the MPEG2 transport stream and converts it into a format appropriate to be stored in a storage medium 135. Then, it is stored in the storage medium 135.

FIG. 3 illustrates a process for converting an MPEG2 transport stream to a format appropriate to be stored in a storage medium 135.

As described above, the home server 130 performs this process in this exemplary embodiment. The stream 310 has a format of an MPEG2 TS transmitted through a transmission channel 112 to the home server 130 during the digital broadcast. Since the stream 310 includes all the packets representing one or more programs, it is called a “full TS”. Accordingly, the stream 310 is a full TS, and each box having the same shading is a packet of one program.

The home server 130 does not store the full TS in a storage medium, but stores a partial TS obtained by extracting only the packets representing the programs selected by a user from the full TS. Therefore, since information relating to programs that a user does not select is not stored, the hard disc capacity can be more effectively used. The stream 320 is a partial TS obtained by extracting only the packets representing one program (i.e., the boxes having the same shading). According to an MPEG2 TS standard, each packet included in the stream (310 or 320) has 188 bytes of data.

Since unnecessary packets have been eliminated from the full TS, time intervals of the packets consisting of the partial TS are not constant. These time intervals may play a critical role in combining all packets and providing users with an uninterrupted video display. Therefore, when the contents are stored in a storage medium, information on the time interval, i.e., recording time stamps, are inserted prior to each packet and then stored in a storage medium.

The stream 330 shows that the headers 341, 342, . . . including the recording time stamps, are inserted prior to each packets 331, 332, . . . . Then, the stream 330 is stored in the storage medium 135.

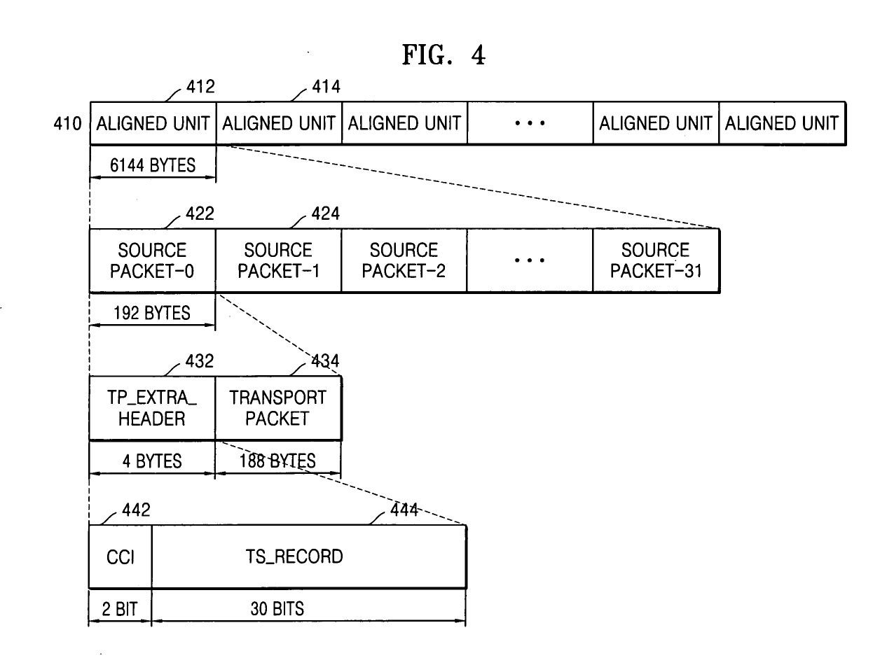

FIG. 4 illustrates a format for storing the MPEG2 TS when a blue ray disk is used as a storage medium. Hereinafter, an MPEG2 TS format stored in a blue ray disc is referred to as a BDAV MPEG TS. The BDAV MPEG2 TS 410 includes one or more aligned units 412, 414, . . . . The aligned unit represents the unit for decrypting the AV data before it is stored in a storage medium, and decrypting data when played back from the storage medium.

Each aligned unit 412 after the decryption includes 32 source packets 422, 424, . . . , each of which contains 192 bytes, i.e., 4 bytes for the header 432 and 188 bytes for the transport packet 434.

The header 432 includes copy control information 442 of 2 bits and a recording time stamp 444 of 30 bits. The transport packet 434 corresponds to one packet included in the MPEG2 TS format (i.e., the stream 310 in FIG. 3).

The copy control information 442 represents the copyability of the packet, including copy_never, copy_allowed, and copy_once.

The recording time stamp 444 represents a time when each packet arrives at the home server. Time intervals between each packet can be computed based on the time stamps 444 of each packet and the clocks used to obtain the time stamps. The clocks for the time stamps typically have a frequency of 27 Mhz. The time intervals between the packets are used as important information for an excellent playback of AV data.

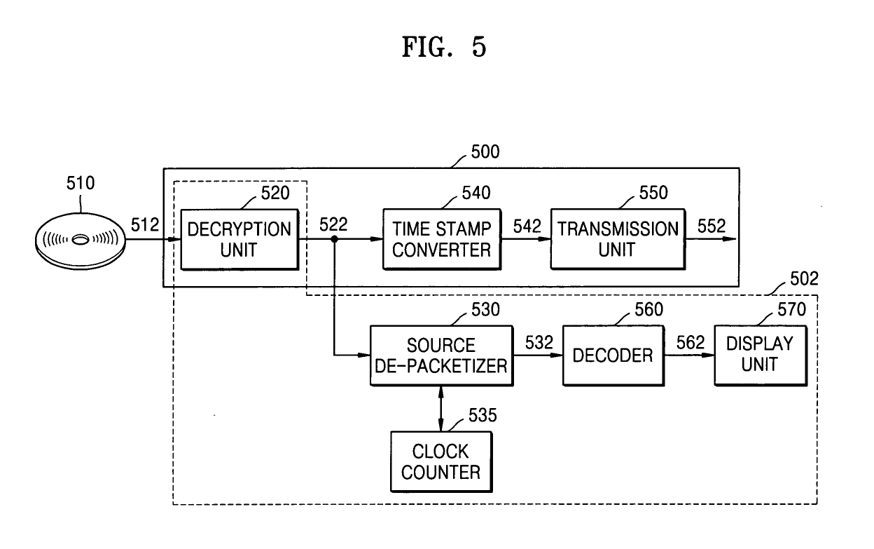

FIG. 5 is a block diagram illustrating a streaming apparatus consistent with one embodiment of the present invention.

All components 510 through 570 shown in FIG. 5 can be incorporated into the home server 130. Since the home server 130 in the home network can perform both a streaming function and a playback function, both a streaming apparatus and a playback apparatus are illustrated for a convenience.

In FIG. 5, a combination of components 520, 540, and 550, blocked by a solid line, is a streaming apparatus 500 consistent with one embodiment of the present invention, and another combination of components 510, 520, 530, 560, and 570, blocked by a dotted line, is a playback apparatus 502 included in the home server 130. The streaming apparatus 500 performs a streaming of the AV data stored in a storage medium 510 to other devices in the home network, and the playback apparatus 502 displays the AV data stored in the storage medium 510 to a user.

Now, operation of a streaming apparatus of FIG. 5 will be described with reference to a streaming architecture of FIG. 4.

A streaming apparatus 500 consistent with an embodiment of the present invention includes a decryption unit 520, a time stamp converter unit 540, and a transmission unit 550.

The decryption unit 520 decrypts the AV data read from the storage medium 510 to produce a source packet 522. The AV data read from the storage medium is the encrypted BDAV MPEG2 TS 410 combined with the aligned unit as shown in FIG. 4. Through the decryption by the decryption unit 520, the AV data 512 is converted into a source packet 522 (corresponding to 422, 424, . . . of FIG. 4). As described in relation to FIG. 4, a source packet 522 includes a header 432 of 4 bytes and a transport packet 434 of 188 bytes, and the header includes a copy control information of 2 bits and a recording time stamp 444 of 30 bits.

The time stamp converter unit 540 extracts the recording time stamp from the source packet 522, and then converts the extracted recording time stamp of m bits into a streaming time stamp of n bits. For example, when the MPEG2 TS is recorded on a BD, the recording time stamp 444 included in the header 432 of the source packet 422, . . . , occupies 30 bits. In addition, the streaming time stamp used for streaming to other devices in the home network according to a DNWG standard, occupies 32 bits.

The transmission unit 550 performs streaming of packets including a streaming time stamp of n bits to other devices according to a predetermined streaming protocol.

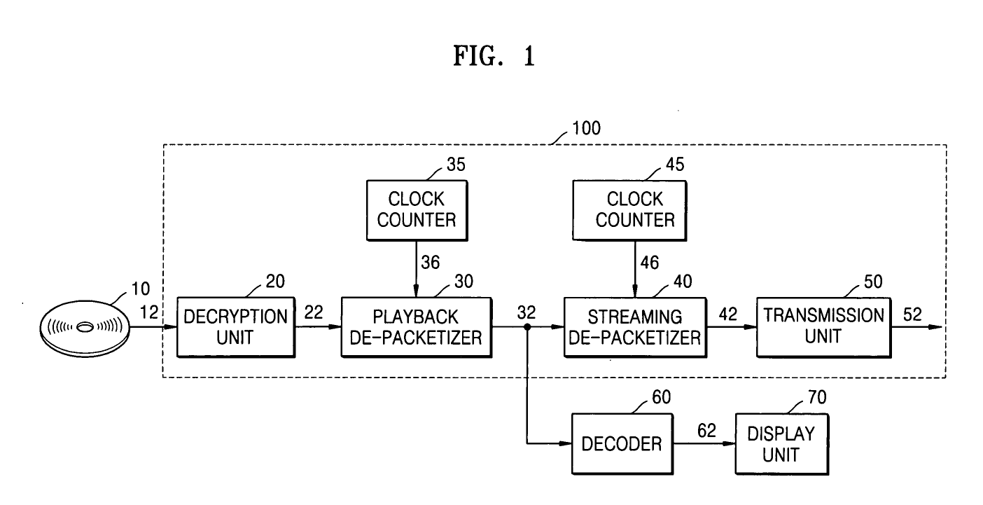

Operation of the playback apparatus 502 of FIG. 5 is similar to that of FIG. 1. Similarly, the source de-packetizer 530 corresponds to the playback de-packetizer 30 of FIG. 1.

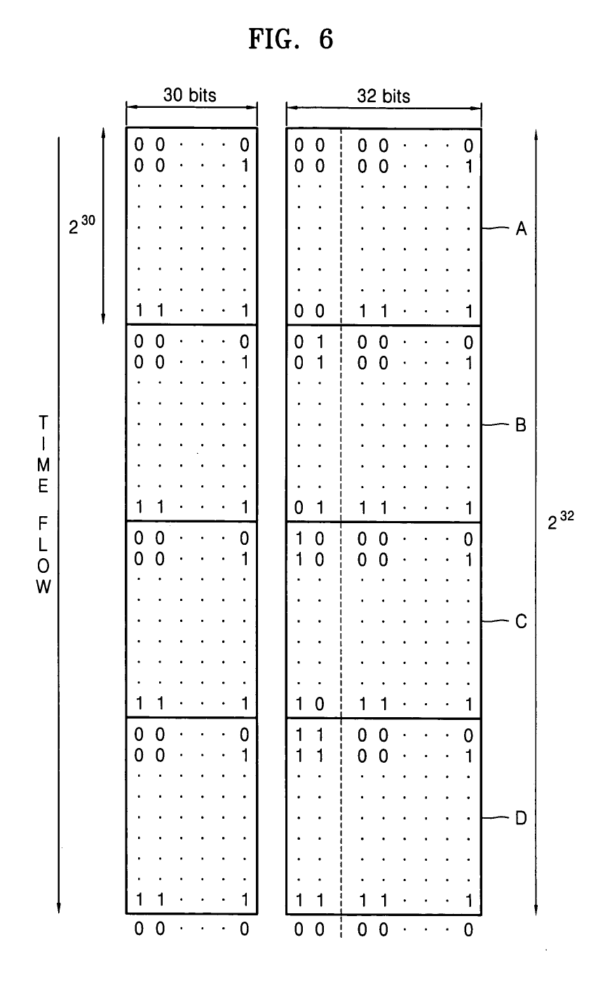

FIG. 6 illustrates a principle of time stamp conversion.

As shown in FIGS. 3 and 4, comparing the MPEG2 TS format recorded on the storage medium with the MPEG2 TS format provided for streaming, the recording time stamp in the source packet has a bit size different from the streaming time stamp, but the time intervals between each packet, represented by the recording time stamp, are equal to those represented by the streaming time stamps. Of course, it is assumed that the same clock cycle is used.

Therefore, if the time stamps have a bit size smaller than p bits (here, p<m and p<n), it is possible to use the original recording time stamp and the original streaming time stamp without conversion. For example, when the recording time stamp has a format size of 30 bits (BD standard) and the streaming time stamp has a format size of 32 bits (DHWG standard), from the first bit to the thirtieth bit, both the time stamps are similarly incremented. However, at the thirty first bit, the recording time stamp is reset to 0 bit, but the streaming time stamp proceeds to increment until the thirty-second bit reaches and then, at the thirty-third bit, it is also reset to 0 bit.

Referring to FIG. 6, it is possible to see a relation between a recording time stamp of 30 bits and a streaming time stamp of 32 bits. The left side of FIG. 6 shows a cyclic period of the recording time stamp of 30 bits, and the right side of FIG. 6 shows a cyclic period of the streaming time stamp of 32 bits. The recording time stamp has a cyclic period of 2³⁰, and the streaming time stamp has a cyclic period of 2³². However, it is also recognized that they are similarly incremented from the first bit to the twenty ninth bit.

Based on these characteristics, the time stamp converter unit 540 converts the recording time stamp of 30 bits into a time stamp format of 32 bits by using a process described below. Herein, Xᵢ denotes a recording time stamp of 30 bits of an i-th packet, and Yᵢ denotes a streaming time stamp of 32 bits of the i-th packet (here, i is any natural number).

The time stamps are incremented based on the following rules.

First, during each period of the recording time stamps (i.e., 2³⁰ bits) shown as blocks A, B, C, and D in FIG. 6, the least significant 30 bits of the streaming time stamp of the i-th packet are equal to those of the recording time stamp.

Secondly, during each period of the recording time stamps (i.e., 2³⁰ bits) shown as blocks A, B, C, and D in FIG. 6, the most significant 2 bits of the steaming time stamp of the i-th packet are equal to those of the streaming time stamp of the (i-1)th packet.

Thirdly, during the time shifts between the blocks A, B, C, and D in FIG. 6, i.e., during a time period more than each period of the recording time stamps (i.e., 2³⁰ bits), the value of the most significant 2 bits of the streaming time stamp of the i-th packet is larger than that of the (i-1)th packet as many as one bit.

Based on the aforementioned three rules, it is possible to derive a process of converting the recording time stamp into the streaming time stamp as follows, where Yᵢ denotes a streaming time stamp of the i-th packet and Xᵢ denotes a recording time stamp of the i-th packet.

First, the most significant 2 bits (i.e., 31 st and 30th bits) of the streaming time stamp Y₁ are filled with “00”, and the remaining lower 30 bits are filled with the recording time stamp X₁.

Then, the recording time stamp Xᵢ is compared with the recording time stamp X₍ᵢ₋₁₎ of the (i-1)th packet.

Subsequently, if it is determined that Xᵢ<Xᵢ₋₁, the most significant 2 bits of Yᵢ are filled with the most significant 2 bits of Y₍ᵢ₋₁₎ plus 1 bit, and the lower 30 bits of Yᵢ are filled with Xᵢ.

Lastly, if it is determined that Xᵢ≧X₍ᵢ₋₁₎, the most significant 2 bits of Yᵢ are filled with the most significant 2 bits of Y₍ᵢ₋₁₎, and the lower 30 bits of Yᵢ are filled with Xᵢ.

These procedures can be expressed as the following table.

TABLE 1

| | Most significant 2 bits of Yᵢ | Lower 30 bits of Yᵢ |
|---|---|---|
| Y₁ | 00 | Xᵢ |
| Yᵢ(Xᵢ < X_{(i - 1)}) | Most significant 2 bits | Xᵢ |
| | of Y_{(i - 1)} + 1 | |
| Yᵢ(Xᵢ ≧ X_{(i - 1)}) | Most significant 2 bits | Xᵢ |
| | of Y_{(i - 1)} | |

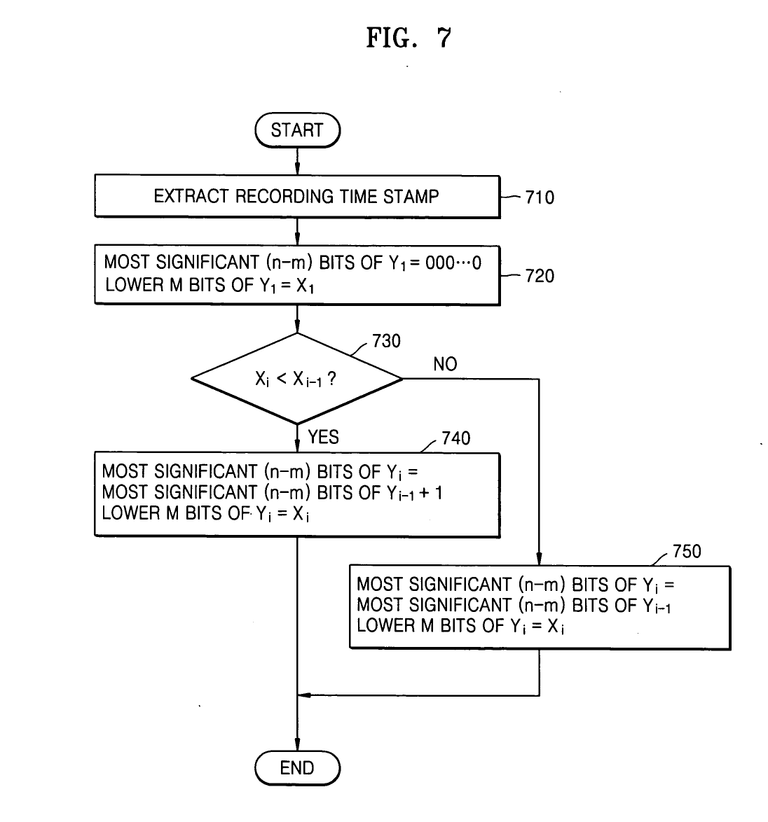

FIG. 7 illustrates a method of converting a recording time stamp into a streaming time stamp consistent with one embodiment of the present invention.

Generalizing the rules of FIG. 6, we can obtain a method of converting a recording time stamp of m bits into a streaming time stamp of n bits (here, m<n) as follows.

In operation 710, the recording time stamp of the i-th packet is extracted.

In operation 720, the most significant (n-m) bits of the streaming time stamp Y₁ of the first packet are filled with “0000 . . . 0 (i.e., m-n zeros)”, and the remaining lower m bits of Yᵢ are filled with Xᵢ.

In operation 730, the recording time stamp Xᵢ of the ith pack-et is compared with the recording time stamp X₍ᵢ₋₁₎ of the (i-1)th packet.

In operation 740, if it is determined that Xᵢ<Xᵢ₋₁, the most significant (n-m) bits of the streaming time stamp Yᵢ are filled with the most significant (n-m) bits of Y₍ᵢ₋₁₎ plus one bit, and the lower m bits of the streaming time stamp Yᵢ of the i-th packet are filled with Xᵢ.

In operation 750, if it is determined that Xᵢ≧X₍ₓ₋₁₎, the most significant (n-m) bits of the streaming time stamp Yᵢ of the i-th packet are filled with the most significant (n-m) bits of Y₍ᵢ₋₁₎, and the lower 30 bits of the streaming time stamp Yᵢ are filled with Xᵢ.

Also, these processes can be expressed as the following table:

TABLE 2

| | Most significant (n-m) bits of Yᵢ | Lower m bits of Yᵢ |
|---|---|---|
| Y₁ | 000 . . . 0 (i.e., n-m zeros) | Xᵢ |
| Yᵢ(Xᵢ < X_{(i - 1)}) | Most significant (n-m) bits | Xᵢ |
| | of Y_{(i - 1)} + 1 | |
| Yᵢ(Xᵢ ≧ X_{(i - 1)}) | Most significant (n-m) bits | Xᵢ |
| | of Y_{(i - 1)} | |

Aspects of the invention can also be embodied as computer readable codes on a computer readable recording medium. The computer readable recording medium can be any data storage device that can store data that can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network-coupled computer systems so that the computer readable code is stored and executed in a distributed fashion. Also, functional programs, codes, and code segments for accomplishing aspects of the present invention can be easily construed by programmers skilled in the art to which the present invention pertains.

Consistent with one embodiment of the present invention, it is possible to provide a streaming method and a streaming apparatus having a simple streaming process by converting the recording time stamp format into the streaming time stamp format without separately generating the recording time stamp and the streaming time stamp.

While aspects of the present invention have been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for streaming AV data to at least one other device, said AV data having packets, at least some of said packets having a recording time stamp of m bits representing temporal information of when the packet is recorded on a storage medium, the apparatus comprising:
a time stamp converter unit converting the recording time stamp of m bits into a streaming time stamp of n bits required for streaming the AV data to said other device, wherein m<n; and
a transmission unit transmitting packets including the streaming time stamp to said other device based on a streaming protocol.

2. The apparatus according to claim 1, wherein the time stamp converter unit generates the streaming time stamp by:
filling most significant (n-m) bits of the streaming time stamp of a first packet with zeros and filling the remaining m bits with the recording time stamp of the first packet; and
filling the most significant (n-m) bits of the streaming time stamp of an i-th packet with a bit value obtained by incrementing the most significant (n-m) bits of the streaming time stamp of an (i-1)th packet when the recording time stamp of the i-th packet of the AV data is smaller than that of the (i-1)th packet.

3. The apparatus according to claim 2, wherein the time stamp converter unit generates the streaming time stamp by filling the most significant (n-m) bits of the streaming time stamp of the i-th packet with the streaming time stamp of the (i-1)th packet when the recording time stamp of the i-th packet of the AV data is larger than or equal to that of the (i-1)th packet.

4. The apparatus according to claim 2, wherein the time stamp converter unit fills lower m bits of the streaming time stamp of the i-th packet with the recording time stamp of the i-th packet.

5. The apparatus according to claim 2, wherein the AV data is streamed from a home server to other devices in a home network according to a digital home networking group standard, the storage medium is a blue-ray disk, the recording time stamp has a format size of 30 bits, and the streaming time stamp has a format size of 32 bits.

6. The apparatus according to claim 2, wherein the AV data corresponds to an MPEG2 transport stream.

7. The apparatus according to claim 2, further comprising a decryption unit extracting the AV data from the storage medium and decrypting the AV data.

8. The apparatus according to claim 7, wherein the AV data is encrypted in the unit of one or more packets, and the decryption is performed based on the unit of one or more packets.

9. A method of streaming AV data to another device, said AV data having packets, at least some of said packets having a recording time stamp of m bits representing temporal information of when the packet is recorded on a storage medium, the method comprising:
converting the recording time stamp of m bits into a streaming time stamp of n bits required for streaming the AV data to said other device (here, m<n); and
transmitting packets including the streaming time stamp to said other device based on a streaming protocol.

10. The method according to claim 9, wherein the conversion of the recording time stamp comprises:
filling most significant (n-m) bits of the streaming time stamp of a first packet with zeros and filling the remaining m bits with the recording time stamp of the first packet; and
filling the most significant (n-m) bits of the streaming time stamp of an i-th packet with a bit value obtained by incrementing the most significant (n-m) bits of the streaming time stamp of an (i-1)th packet when the recording time stamp of the i-th packet of the AV data is smaller than that of the (i-1)th packet.

11. The method according to claim 10, wherein the conversion of the recording time stamp further comprises filling the most significant (n-m) bits of the streaming time stamp of the i-th packet with the most significant (n-m) bits of the streaming time stamp of the (i-1)th packet when the recording time stamp of the i-th packet of the AV data is larger than or equal to that of the (i-1)th packet.

12. The method according to claim 10, wherein the conversion of the recording time stamp further comprises filling lower m bits of the streaming time stamp of the i-th packet with the recording time stamp of the i-th packet.

13. The method according to claim 10, wherein the AV data is streamed from a home server to other devices in a home network according to a digital home networking group standard, the storage medium is a blue-ray disk, the recording time stamp has a format size of 30 bits, and the streaming time stamp has a format size of 32 bits.

14. The method according to claim 10, wherein the AV data corresponds to a MPEG2 transport stream.

15. The method according to claim 10, further comprising extracting the AV data from the storage medium and decrypting the AV data.

16. The method according to claim 10, wherein the AV data is encrypted in the unit of one or more packets, and the decryption is performed based on the unit of one or more packets.

17. A method of converting a recording time stamp of m bits of AV data containing one or more packets into a streaming time stamp of n bits wherein m<n, comprising:
extracting the recording time stamp of an i-th packet;
filling most significant (n-n) bits of the streaming time stamp of a first packet with zeros and filling remaining lower m bits with the recording time stamp of the first packet;
comparing the recording time stamp Xᵢ of the i-th packet with the recording time stamp X₍ᵢ₋₁₎ of the (i-1)th packet; and
filling most significant (n-n) bits of the streaming time stamp Yᵢ of an i-th packet with a bit value obtained by incrementing the most significant (n-m) bits of the streaming time stamp Y₍ᵢ₋₁₎ of an (i-1)th packet and filling the lower m bits of the streaming time stamp Yᵢ of the i-th packet with the recording time stamp Xᵢ when Xᵢ<_{X(i-1)}.

18. The method according to claim 17, further comprising filling most significant (n-m) bits of the streaming time stamp Yᵢ of the i-th packet with the most significant (n-n) bits of the streaming time stamp Y₍ᵢ₋₁₎ and filling the lower n bits of the streaming time stamp Yᵢ of the i-th packet with the recording time stamp Xᵢ of the i-th packet when Xᵢ≧X₍ᵢ₋₁₎.

19. A home server in a digital home network comprising the apparatus of streaming AV data according to claim 1.

20. A computer readable recording medium comprising a program for executing the method of streaming AV data according to claim 1 in a computer.
